(19) United States
(12) Patent Application Publication
(10) Pub. No.: US 2014/0272756 A1
(43) Pub. Date: Sep. 18, 2014

(54) DEVICE FOR TREATING THE TEMPOROMANDIBULAR JOINT

(71) Applicant: Aladin SABBAGH, Nuernberg (DE)

(72) Inventor: Aladin SABBAGH, Nuernberg (DE)

(21) Appl. No.: 14/048,567

(22) Filed: Oct. 8, 2013

(30) Foreign Application Priority Data
Mar. 13, 2013 (DE) 20 2013 002 401.

(51) Int. Cl. A61C 7/00

(52) U.S. Cl. CPC A61C 7/00
USPC 433/18

(57) ABSTRACT

The invention relates to a device for treating the temporomandibular joint, comprising a pad (1) for resting against the occlusal surface of the molar on the left-hand side and a pad (1) for resting against the occlusal surface of the molar on the right-hand side, wherein the pads (1) are formed from a sleeve produced from a flexible material, said sleeve being filled with a fluid, and wherein the two pads (1) are interconnected via a tube (3) for fluid exchange. To improve the wearing comfort of the device, it is proposed in accordance with the invention for a wire (4) for stabilising a shape of the tube (3) to be provided in the tube (3).

The invention relates to a device for treating the temporomandibular joint according to the preamble of claim 1.

Such a device is known from DE 102 39 464 B4 and from U.S. Pat. No. 6,978,786 B2. In the known device, a clamping shoe is provided on each pad for fastening to the molar in a clamping manner. The clamping shoe is found to be uncomfortable by patients, resulting in an urge to gag. Apart from this, the production of said clamping shoe is complex.

The object of the invention is to overcome the disadvantages according to the prior art. In particular, a device for treating the temporomandibular joint that is comfortable to wear is to be specified. In accordance with a further objective of the invention, the device is to be producible as easily and cost effectively as possible.

This object is achieved by the features in claim 1. Expedient embodiments of the invention emerge from the features in claims 2 to 6.

In accordance with the invention, it is proposed for a wire to be provided in the tube, said wire stabilising the shape of the tube.—By bending the wire, the shape of the tube and therefore the shape of the device can be adapted to the shape of a mandibular arch of the respective patient. There is no need for the provision of clamping shoes on the pads. The proposed device can be produced easily and cost effectively. In addition, it is comfortable to wear due to the omission of the clamping shoe.

In accordance with an advantageous embodiment of the invention, the tube has a curved shape corresponding to a mandibular arch. Since the tube has a curved shape matched approximately to the mandibular arch from the outset, no kinks or waves in the tube, which could be considered uncomfortable by patients wearing the device, are produced when the bend of the tube is matched to the shape of the mandibular arch by bending the wire.

The wire is expediently formed from a rustproof metal. It may have a diameter in the range from 0.3 to 2.0 mm, preferably 0.4 to 1.5 mm. Such a wire lends the tube sufficient dimensional stability. By bending the wire, the shape of the tube can be changed. The changed shape of the tube is held by the wire in a stable manner.

In accordance with a further embodiment of the invention, the tube is arranged in a plane and, via connecting pieces produced in one piece with said tube, is connected at both of its ends to the pads in such a way that the pads are arranged above the plane. Since the connecting pieces deflect from the two tube ends such that the pads are arranged above a plane formed by the tube, the wire cannot be displaced into the region of the pads. It is thus ensured that the wire is held in the tube.

In accordance with a further embodiment, the connecting pieces are attached to the pads such that the pads, in plan view, are arranged at least in part within an area that is defined by the tube and a virtual line connecting the tube ends. In other words, the pads are connected in the region of their buccal edges to the connecting pieces. The connecting pieces are attached in particular to a corner of the pads that points towards the pharyngeal zone when the device is worn.

An exemplary embodiment of the invention will be explained in greater detail hereinafter with reference to the drawings, in which:

FIG. 1 shows a schematic plan view on a device, and

FIG. 2 shows a side view according to FIG. 1.

In the device shown in the figures, two pads 1 produced from a flexible and preferably transparent plastic material are connected via connecting pieces 2 to a tube 3 bent in a semi-circular manner. The pads 1, the connecting pieces 2 and also the tube 3 form, in one piece, a closed sleeve, within which a fluid is received. A wire 4 is also received inside the tube 3.

As can be seen in particular from FIG. 2, the connecting pieces 2 each extend from a respective end of the tube 3 in such a way that the pads 1 are arranged in a plane above a plane formed by the tube 3. As a result, the wire 4 cannot slip into the pads 1.

The wire 4 has a diameter of 1 mm for example and is produced from a rustproof material. The metal used to produce the wire 4 is selected such that the wire 4 can be bent. The wire 4 is so stable in the bent state that the shape thereof is thus forced upon the tube 3. It is thus possible to match the shape of the device, in particular of the tube 3, to the curvature of a patient's mandibular arch.

In FIG. 1, an area F is defined by the tube 3 and also a virtual line L, which interconnects the tube ends of the tube 3. The pads 1 are attached to the connecting pieces 2 in such a way that they are located in part within the area F. The pads 1 are attached on their buccal sides to the connecting pieces 2.

The proposed device has the advantage that it is comfortable to wear for the patient and can be produced in a simple manner.

### LIST OF REFERENCE SIGNS

1 pad
2 connecting piece
3 tube
4 wire
F area
L line

1. A device for treating the temporomandibular joint, comprising a pad (1) for resting against the occlusal surface of the molar on the left-hand side and a pad (1) for resting against the occlusal surface of the molar on the right-hand side,
wherein the pads (1) are formed from a sleeve produced from a flexible material, said sleeve being filled with a fluid, and
wherein the two pads (1) are interconnected via a tube (3) for fluid exchange, characterised in that
a wire (4) for stabilising a shape of the tube (3) is provided in the tube (3).

2. The device according to claim 1, wherein the tube (3) has a curved shape corresponding to a mandibular arch.

3. The device according to claim 1, wherein the wire (4) is formed from a rustproof metal.

4. The device according to claim 1, wherein the wire (4) has a diameter from 0.3 to 2.0 mm, preferably 0.4 to 1.5 mm.

5. The device according to claim 1, wherein the tube (3) is arranged in a plane and, via connecting pieces (2) produced in one piece with said tube (3), is connected at its two ends to the pads (1) in such a way that the pads (1) are arranged above the plane.

6. The device according to claim 1, wherein the connecting pieces (2) are attached to the pads (1) such that the pads (1), in plan view, are arranged at least in part within an area (F) that is defined by the tube (3) and a virtual line (L) connecting the tube ends.
